(19) United States
(12) Patent Application Publication
(10) Pub. No.: US 2008/0195805 A1
(43) Pub. Date: Aug. 14, 2008

(54) Micro Controller Unit System Including Flash Memory and Method of Accessing the Flash Memory By the Micro Controller Unit

(76) Inventor: Kyoung Hwan Kwon, Seoul (KR)

Correspondence Address: F. CHAU & ASSOCIATES, LLC, 130 WOODBURY ROAD, WOODBURY, NY, 11797, US

(21) Appl. No.: 11/833,024

(22) Filed: Aug. 2, 2007

(30) Foreign Application Priority Data
Feb. 8, 2007 (KR) 10-2007-0013240

(51) Int. Cl. G06F 12/06; G06F 12/00

(52) U.S. Cl. 711/104; 711/157; 711/E12.008

(57) ABSTRACT

A micro controller unit (MCU) system and a flash memory accessing method performed by the MCU system are provided. In the flash memory accessing method, when a first address, which is currently accessed, is inconsecutive to a second address, which is accessed next to the first address, an MCU that accesses a plurality of flash memory blocks using an interleaving technique performs an address operation cycle on the second address. At substantially the same time, one of the flash memory blocks that includes an address next to the first address stores the next address of the first address and data of the next address in one of a plurality of registers.

### CROSS-REFERENCE TO RELATED PATENT APPLICATIONS

This application claims priority under 35 U.S.C. §119 to Korean Patent Application No. 10-2007-0013240, filed on Feb. 8, 2007, the disclosure of which is hereby incorporated by reference in its entirety.

### BACKGROUND OF THE INVENTION

1. Technical Field

The present disclosure relates to a micro controller unit (MCU) system, and more particularly, to a micro controller unit system including flash memory and a method of accessing the flash memory by the micro controller unit.

2. Discussion of the Related Art

Embedded micro controller units (MCUs), for example, 32-bit MCUs, have been developed to execute code without the need for external memory by including a flash memory.

The inclusion of flash memory has allowed for the unlimited updating of code in MCUs, however, the operating speed of the flash memory is restricted. Thus, for high speed applications, MCUs including flash memories are often problematic. Well-known interleaving techniques may be used to facilitate the use of MCUs in high-speed applications. When consecutive addresses are accessed using an interleaved flash memory, a latency or delay must occur before the contents of the flash memory can be consecutively read.

FIG. 1 is a graph showing a method in which a conventional MCU accesses consecutive addresses of a flash memory according to an interleaving technique. Referring to FIG. 1, in order to access the flash memory, first, the conventional MCU waits until a memory that is to be initially accessed (i.e., a first flash memory) is prepared in operation S1. When the first flash memory is completely prepared, the MCU can access the first flash memory, in operation S2. While the MCU is accessing the first flash memory in operation S2, a second flash memory undergoes a preparation operation so that the MCU can access the second flash memory, in operation S2. After accessing the first flash memory, the MCU can immediately access the second flash memory, in operation 83.

While the MCU is accessing the second flash memory in operation S3, the first flash memory is re-prepared to be re-accessed by the MCU. After accessing the second flash memory, the MCU can immediately access the first flash memory in operation S4. As such, the use of the interleaved flash memory helps the MCU to consecutively access the flash memory without further delay after the initial latency (i.e., the latency in operation S1). However, this address accessing method can only be used when the MCU accesses the consecutive addresses of the flash memory.

When the MCU accesses a first address and then accesses a second address that does not follow right after the first address, the MCU may have to use one cycle in order to calculate the second address. Because the second address is not consecutive to the first address, while one flash memory (e.g., the first flash memory) is being accessed as shown in FIG. 1, the other flash memory (e.g., the second flash memory) cannot be prepared in advance because it cannot be aware of which address the MCU will access. Accordingly, the advantages of the interleaving technique cannot be efficiently obtained.

The access to inconsecutive addresses may frequently occur when an instruction for accessing data is performed. Instructions that an MCU accesses may be classified into an instruction which is itself accessed and an instruction which includes information which is used when the instruction is accessed and then data is also accessed. For example, a load or store instruction includes information that includes the location of data to be load or stored. When accessing the load or store instruction, the MCU also accesses the to-be-loaded or to-be-stored data on the basis of the information included in the instruction.

FIG. 2 is a graph showing a method in which a conventional MCU accesses inconsecutive addresses of a flash memory according to an interleaving technique. Referring to FIG. 2, when consecutive instructions include data to be accessed, the conventional MCU first enters into a latency or wait state in order to access a first instruction existing in a first flash memory, in operation S10.

Thereafter, the conventional MCU accesses the first instruction in operation S11, and at the same time a second flash memory performs a preparation operation. However, after the conventional MCU accesses the first instruction, it accesses first data for the first instruction. The first data exists in an address that is not consecutive to the first instruction, so that the conventional MCU may use one cycle in order to carry out an operation on the address of the first data.

Accordingly, while the operation on the address of the first data is being performed, the second flash memory cannot perform an operation in operation S12. Also, in operation S12, the first flash memory enters into an idle state Id. When the operation, on the address of the first data is completed, the conventional MCU accesses the first data on the basis of the result of the operation on the first data's address. In order to re-access the first flash memory, the conventional MCU waits in operation S13, and thereafter can access the first data in operation S14.

While the first data is being accessed in operation S14, the second flash memory can be prepared. However, after accessing the first data, the conventional MCU carries out an operation on the address of a second instruction in operation S15, because the second instruction, which is to be accessed after the first data, has an address not consecutive to the first data. Thus, the MCU cannot access the second flash memory, and the second flash memory cannot perform an operations in operation S15. Then, the MCU accesses the second instruction included in the second flash memory according to a method similar to the above-described method of accessing the first instruction.

As illustrated in FIG. 2, when inconsecutive addresses are accessed, the advantages of a flash memory access based on an interleaving technique may not be realized.

### SUMMARY OF THE INVENTION

Exemplary embodiments of the present invention provide a method and system for reducing the wait state of a micro controller unit (MCU) and efficiently accessing a flash memory included in the system even when the MCU accesses inconsecutive addresses using an interleaving technique.

According to an aspect of the present invention, there is provided a flash memory accessing method performed by an MCU which accesses a plurality of flash memory blocks using an interleaving technique. In the flash memory accessing method, when a first address, which is currently accessed, is inconsecutive to a second address, which is accessed next to the first address, the MCU performs an address operation cycle on the second address, and at the same time one of the flash memory blocks that includes an address next to the first address stores the next address of the first address and data of the next address in one of a plurality of registers.

The flash memory accessing method may further include the operation of the MCU comparing a third address to be accessed next to the second address with the next address stored in one of the registers to access the third address after accessing the second address, and when the third address is the same as the stored next address, the operation of the MCU accessing the data of the next address stored in one of the registers.

In the operation of storing the next address of the first address and the data of the next address, the flash memory block including the address next to the first address stores the next address of the first address and the data of the next address in an instruction register of the registers when the first address is an instruction address.

In the operation of storing the next address of the first address and the data of the next address, the flash memory block including the address next to the first address stores the next address of the first address and the data of the next address in a data register of the registers when the first address is a data address.

The operation of comparing the third address with the next address stored in one of the registers may include selecting one of the registers, using flash control logic, on the basis of a code distinguishment signal output from the micro controller unit. The next address stored in the selected register is compared with the third address output from the micro controller unit using the flash control logic.

When the third address is different from the stored next address, the flash memory accessing method may further include the operation of the micro controller unit accessing one of the flash memory blocks on the basis of the third address.

According to another aspect of the present invention, there is provided a flash memory embedded micro controller unit system including a plurality of flash memory blocks. A micro controller unit accesses the flash memory blocks according to an interleaving technique. According to a flash control logic, when a first address, which is currently accessed, is inconsecutive to a second address, which is accessed next to the first address, the flash control logic controls one of the flash memory blocks that includes an address next to the first address to store the next address of the first address and data of the next address in one of a plurality of registers while the micro controller unit is performing an address operation cycle on the second address.

The micro controller unit can access a third address to be accessed next to the second address after accessing the second address. The flash control logic may compare the third address with the next address stored in one of the registers. When the third address is the same as the stored next address, the micro controller unit may access the data of the next address stored in one of the registers.

One of the registers is an instruction register. The flash control logic may control the flash memory block including the address next to the first address to store the next address of the first address and the data of the next address in the instruction register when the first address is an instruction address.

One of the registers is a data register. The flash control logic may control the flash memory block including the address next to the first address to store the next address of the first address and the data of the next address in the data register when the first address is a data address.

The flash control logic may select one of the registers on the basis of a code distinguishment signal output from the micro controller unit and compare the next address stored in the selected register with the third address output from the micro controller unit. The third address is therefore compared with the next address stored in one of the registers.

When the third address is different from the next address stored in one of the registers, the micro controller unit may access one of the flash memory blocks on the basis of the third address.

The flash memory embedded micro controller unit system may further include a selector which selects either one of the registers or the data stored in one of the flash memory blocks under the control of the flash control logic. The micro controller unit accesses data selected by the selector.

### BRIEF DESCRIPTION OF THE DRAWINGS

The above and other features and aspects of the present invention will become more apparent by describing in detail exemplary embodiments thereof with reference to the attached drawings in which:

FIG. 1 is a graph showing a method in which a conventional micro controller unit (MCU) accesses consecutive addresses of a flash memory according to an interleaving technique;

FIG. 2 is a graph showing a method in which a conventional MCU accesses inconsecutive addresses of a flash memory according to an interleaving technique;

FIG. 3 is a block diagram of a MCU system including a flash memory, according to an exemplary embodiment of the present invention;

FIG. 4 is a graph showing a method in which the MCU illustrated in FIG. 3 accesses inconsecutive addresses of the flash memory according to an interleaving technique, according to an exemplary embodiment of the present invention; and

FIG. 5 illustrates the data storage state of a flash memory according to an exemplary embodiment of the present invention.

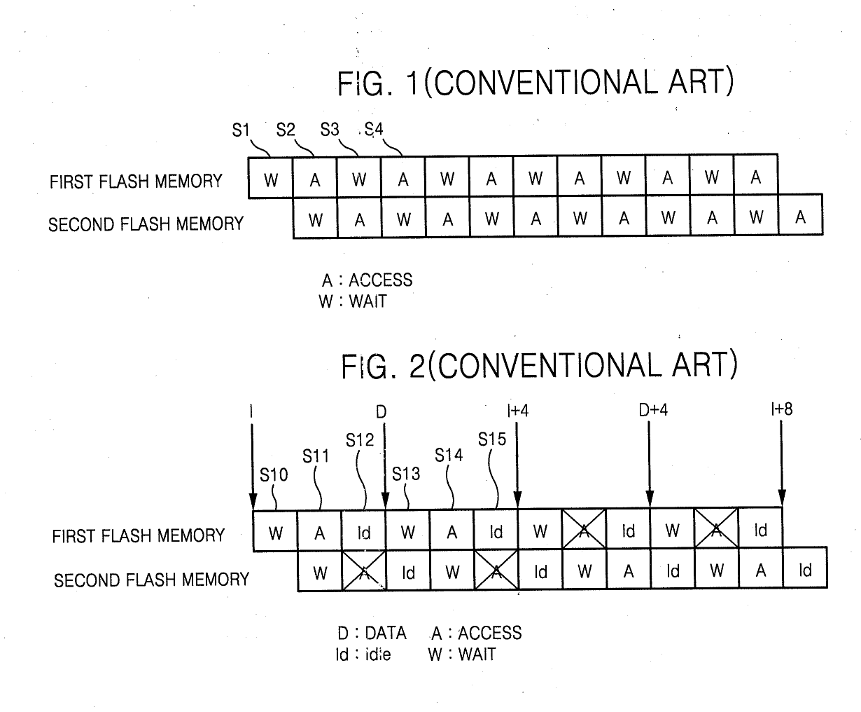

### DETAILED DESCRIPTION OF EXEMPLARY EMBODIMENTS

Exemplary embodiments of the present invention will now be described more fully with reference to the accompanying drawings.

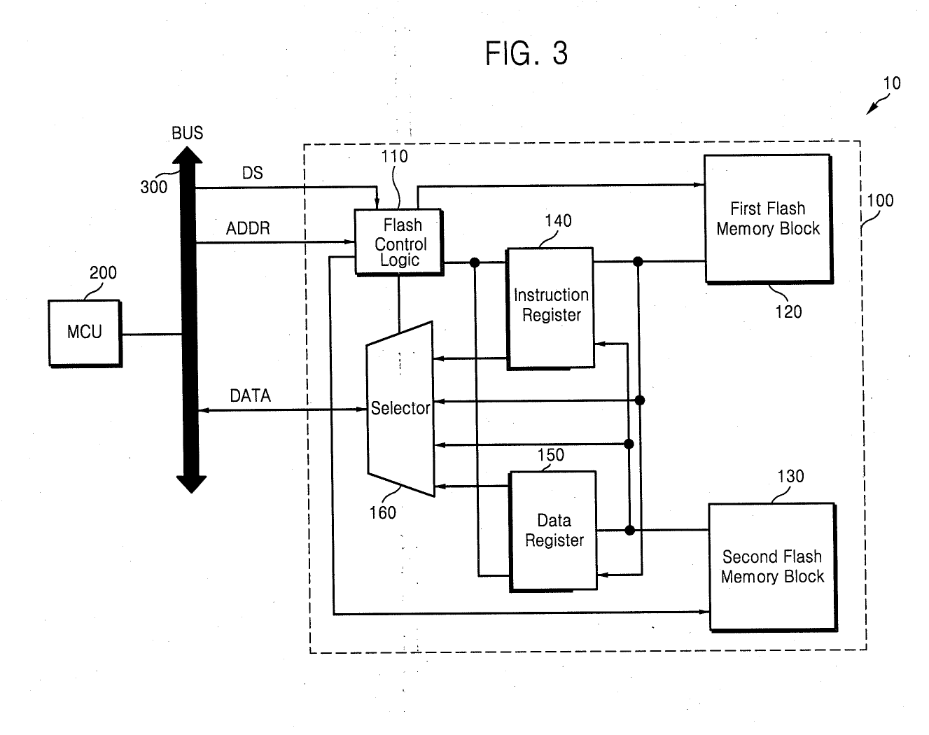

Referring to FIG. 3, a flash memory-embedded micro controller unit (MCU) system 10 according to an exemplary embodiment of the present invention may include a flash memory unit 100 and an MCU 200.

The flash memory unit 100 may include a plurality of flash memory blocks 120 and 130 and a flash control logic 110. The flash memory unit 100 may further include a plurality of registers, namely, an instruction register 140 and a data register 150, and/or a selector 160.

Although the flash memory-embedded MCU system 10 including the two flash memory blocks 120 and 130 is illustrated in FIG. 3, the present invention is not limited thereto. The flash memory-embedded MCU system 10 may include any number of flash memory blocks. The flash memory blocks are interleaved and the MCU 200 can access the flash memory blocks in a pipeline manner.

The MCU 200 may access the flash memory blocks 120 and 130 according to an interleaving technique. To achieve this, the MCU 200 may output an address signal ADDR and a distinguishment signal DS to the flash memory unit 100 via a bus 300.

The distinguishment signal DS may be a flag signal indicating whether the MCU 200 desires to access an instruction or access data on the basis of information included in the instruction. The MCU 200 may also output to the flash memory unit 100 a flag signal that indicates how big (e.g., 8 bit, 16 bit, or 32 bit) content that the MCU 200 currently desires to access is. Alternatively, or additionally, a flag signal may be output that indicates whether the content that the MCU 200 currently desires to access exists in an address consecutive to a previous instruction or previously accessed data.

When a first address, which is currently accessed by the MCU 200, is not consecutive to a second address to be accessed next to the first address, the flash control logic 110 may control the flash memory block 120 or 130. One of the two flash memory blocks 120 and 130 that includes an address next to the first address stores a next address of the first address and data of the next address in any one of the plurality of registers 140 and 150 while performing an address operation cycle on the second address.

As described above, a case where the MCU 200 repeatedly accesses inconsecutive addresses of the flash memory block 120 or 130 may be a case where there consecutively exist instructions (e.g., load or store instructions) to access an instruction and then re-access data on the basis of information included in the instruction.

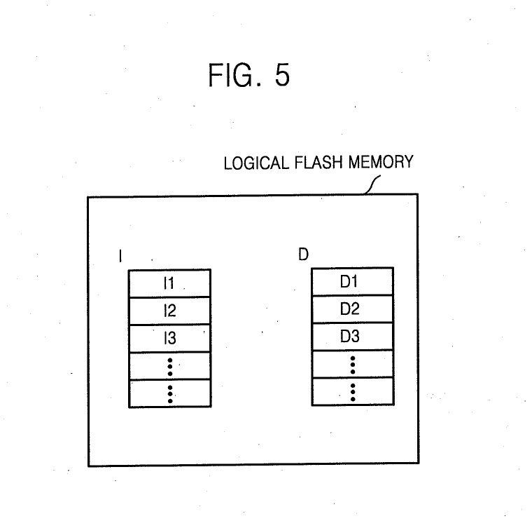

FIG. 5 illustrates the data storage state of a flash memory according to an exemplary embodiment of the present invention. Referring to FIGS. 3 to 5, a case where instructions (e.g., load or store instructions) for accessing consecutive data may be a general case where instructions are consecutively stored in the flash memory block 120 or 130 and data is also consecutively stored in the flash memory block 120 or 130.

The consecutive storage denotes continuation of logical addresses. When two addresses exist in the two different flash memory blocks 120 and 130, the two addresses may be recognized to be consecutive. This is because the flash memory blocks 120 and 130 are interleaved one after the other.

As illustrated in FIG. 5, instructions I1, I2, . . . are consecutively stored, and data D1, D2, . . . may also be consecutively stored in the flash memory block 120 or 130. However, the instructions I1, I2, etc. and the data D1, D2, etc. may be stored in inconsecutive addresses. It may be assumed that the addresses of the first instruction I1 and the first data D1 are referred to as I and D, respectively, and that the addresses next to the addresses I and D of the first instruction I1 and the first data D1 are referred to as (I+4) and (D+4), respectively.

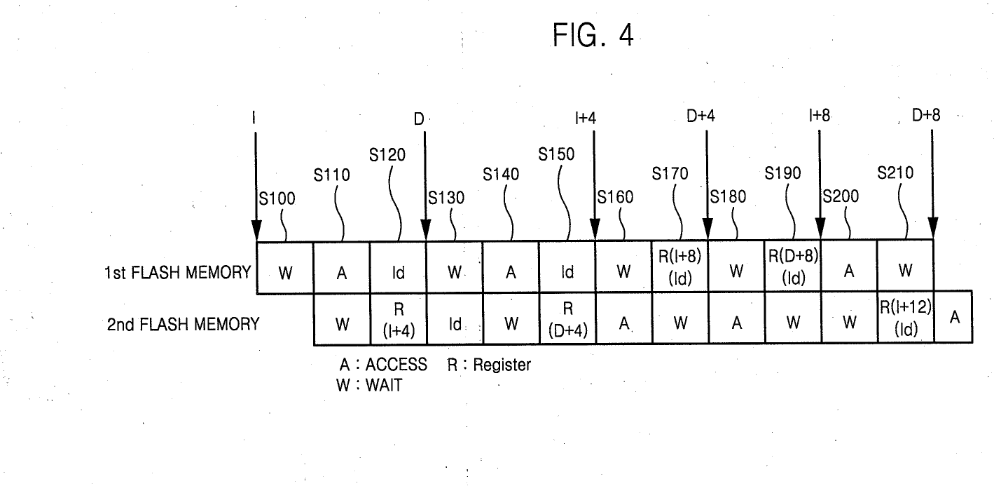

FIG. 4 is a graph showing a method in which the MCU 200 of FIG. 3 accesses inconsecutive addresses of a flash memory according to an interleaving technique, according to an exemplary embodiment of the present invention. Referring to FIGS. 3, 4, and 5, the MCU 200 enters into an initial wait state in operation S100, and then can access the first instruction I1 included in the first flash memory block 120 in operation S110. At this time, the second flash memory block 130 performs a preparation operation.

After accessing the first instruction I1, the MCU 200 should access the first data D1 on the basis of the first instruction I1. A first address (e.g., the address I of the first instruction I1), which is presently accessed, is not consecutive to a second address (e.g., the address D of the first data D1), which is to be accessed next. Of course, a determination as to whether addresses to be accessed are consecutive or inconsecutive may be made by the flash control logic 110 on the basis of a flag signal representing whether the content to be accessed exists in an address consecutive to a previous instruction or previously accessed data, when the MCU 200 further outputs the flag signal to the flash memory unit 100 as described above.

Accordingly, while the MCU 200 is performing an address operation cycle on the second address (i.e., the address D) in operation S120, the flash control logic 110 may control the second flash memory block 130, which includes an address next to the first address, to store the next address (e.g., an address (I+4) of the second instruction I2) and data of the next address in the instruction register 140 in operation S120.

The MCU 200 discussed above is an MCU for accessing a 32-bit flash in units of 32 bits, but the present invention is not limited thereto. For example, when the MCU 200 is an MCU for accessing a 32-bit flash in units of 16 bits, the first address (e.g., the address I of the first instruction I1) may be the same as the next address (e.g., the address of the second instruction I2). Thus, the next address may denote an address which is logically the same as the first address. The address next to the first address may denote an address that is logically consecutive to the first address.

For example, as an alternative to what is shown in FIG. 2, while the MCU 200 is performing an address operation cycle in operation S120, the second flash memory block 130 may store the address and content of the address (I+4) next to the first address I in the register 140 or 150 in operation S120. When the content of the first address is an instruction, it may be stored in the instruction register 140. When the content of the first address is data, it may be stored in the data register 150.

The MCU 200 may access the first data D1 included in the first flash memory block 120 on the basis of the result of the address operation cycle, in operation S140. Before accessing the first data D1, the MCU 200 may be in a wait state until the first flash memory block 120 is prepared to be accessed, in operation 3130. After accessing the first data D1 in operation S140, the MCU 200 should access the second instruction I2. However, the address D of the first data D1 and the address (I+4) of the second instruction I2 are inconsecutive.

Accordingly, while the MCU 200 is performing an address operation cycle on the address (I+4) of the second instruction I2 in operation S150, the flash control logic 110 may control the second flash memory block 130. The second flash memory block 130 may include a next address (D+4) of the address D of the first data D1, to store the next address D+4 and data of the next address D+4 in the data register 150 in operation S150. The flash control logic 110 may compare the address of the second instruction I2, which is a result of the address operation in operation S150, with the next address I+4 stored in the instruction register 140 in operation S120.

Since the operated address and the stored address are the same, the MCU 200 can access the data of the second instruction I2 stored in the instruction register 140 in operation S120, in operation S160, without a wait state. The flash control logic 110 can recognize whether content to be accessed is an instruction or data, on the oasis of the distinguishment signal DS output from the MCU 200. Accordingly, when an address stored in the register 140 or 150 is equal to an address operation result received from the MCU 200, the flash control logic 110 can control the selector 160 so that the MCU 200 accesses the content stored in the register 140 or 150 rather than accessing one of the flash memory blocks 120 and 130.

Accordingly, the MCU 200 accesses the content stored in a corresponding register, so that a wait state for preparing for a flash memory is not needed. After accessing the second instruction I2, the MCU 200 should access the second data D2. However, the address I+4 of the second instruction I2 and the address D+4 of the second data D2 are not consecutive.

Accordingly, while the MCU 200 is performing an address operation cycle in operation S170, the first flash memory block 120 including a next address I+3 of the address I+4 of the second instruction I2 can store the address value of the next address I+3 and the data of the next address I+8 in the instruction register 140 under the control of the flash control logic 110, in operation S170. The flash control logic 110 may compare the address D+4 of the second data D2, which is a result of the address operation in operation S170, with the next address D+4 stored in the data register 150 in operation S150.

Since the operated address and the stored address are the same, the MCU 200 can access the data of the second data D2 stored in the data register 150 in operation S150, in operation S180 without a wait state. After accessing the second data D2, the MCU 200 should access the third instruction I3. However, the address I+8 of the third instruction I3 and the address D+4 of the second data D2 are not consecutive.

Accordingly, while the MCU 200 is perforating an address operation cycle in operation S190, the first flash memory block 120 including a next address D+3 of the address D+4 of the second data D2 can store the address value of the next address D+8. The data of the next address D+8 can be stored in the data register 150 under the control of the flash control logic 110, in operation S190.

Also, the flash control logic 110 may compare the address I+8 of the third instruction I3, which is a result of the address operation in operation S190, with the next address I+8 stored in the instruction register 140 in operation S170. Since the operated address and the stored address are the same, the MCU 200 can access the data of the third instruction I3 stored in the instruction register 140 in operation S170, in operation S200 without a wait state. The following process is similar to the above-described process.

Compared with FIG. 2, the MCU 200 can access more codes within a predetermined period of time. Thus, the performance of the flash memory embedded MCU system 10 is increased. Also, the flash memory embedded MCU system 10 repeatedly performs instructions (e.g., load or store instructions) which accompany an access of data based on information included in the instructions after being accessed as described above. When the other instructions are interposed therebetween, the performance of the flash memory embedded MCU system 10 is increased.

In contrast with a conventional flash memory accessing method in which flash memories do not perform any operations while performing an address operation cycle, in a flash memory accessing method according to an exemplary embodiment of the present invention, the flash memory blocks are controlled while an address operation cycle is being performed.

The flash memory accessing method according to an exemplary embodiment of the present invention may be applied when an MCU accesses peripheral devices other than a flash memory and then accesses the flash memory. When the MCU 200 accesses a peripheral device (not shown) such as an SRAM, the flash control logic 110 stores an address to be accessed next and the content stored in the next address in a corresponding register. Then, when the access to the peripheral device (not shown) and then the flash memory 100 is accessed, the content stored in the corresponding register can be immediately accessed. Thus, the flash memory accessing method according to the present invention can be applied.

As described above, in a flash memory accessing method performed by an MCU according to the present invention, even when the MCU, accessing an embedded flash memory using an interleaving technique, accesses inconsecutive addresses, the wait state of the MCU is reduced, and the flash memory can be effectively accessed. Therefore, the performance of a flash memory embedded MCU system increases.

While exemplary embodiments of the present invention have been particularly shown and described with reference to exemplary embodiments thereof, it will be understood by those skilled in the art that various changes in form and details may be made therein without departing from the spirit and scope of the invention.

What is claimed is:

1. A method for accessing a flash memory using a micro controller unit, comprising:
determining whether a first address is consecutive to a second address; and
performing an address operation cycle on the second address and a flash memory block that includes an address that is next to the first address when the first address is not consecutive to the second address storing a next address of the first address and data of the next address in one of a plurality of registers.

2. The method of claim 1, wherein the micro controller unit accesses a plurality of flash memory blocks using an interleaving technique.

3. The method of claim 1, wherein the address operation cycle is performed by the micro controller unit.

4. The method of claim 1, wherein the address operation cycle on the second address and a flash memory block that includes an address that is proximate to the first address occur at substantially the same time.

5. The method of claim 1, further comprising:
comparing a third address to be accessed next to the second address with the next address, using the micro controller unit; and
accessing the data of the next address stored in one of the registers, using the micro controller unit, when the third address is the same as the stored next address.

6. The method of claim 1, wherein the storing of the next address of the first address and the data of the next address comprises storing the next address of the first address and the data of the next address in an instruction register of the plurality of registers when the first address is an instruction address.

7. The method of claim 1, wherein the storing of the next address of the first address and the data of the next address comprises storing the next address of the first address and the data of the next address in a data register of the plurality of registers when the first address is a data address.

8. The method of claim 5, wherein the comparing of the third address with the next address stored in one of the registers comprises:
selecting one of the registers on the basis of a code distinguishment signal output from the micro controller unit; and
comparing the next address stored in the selected register with the third address output from the micro controller unit.

9. The method of claim 5, further comprising accessing one of the flash memory blocks on the basis of the third address when the third address is different from the stored next address.

10. A flash memory embedded micro controller unit system comprising:
a plurality of flash memory blocks;
a micro controller unit accessing the flash memory blocks according to an interleaving technique; and
a flash control logic,
wherein when a first address, which is currently accessed, is inconsecutive to a second address, which is accessed next to the first address, the flash control logic controls one of the flash memory blocks that includes an address next to the first address to store the next address of the first address and data of the next address in one of a plurality of registers while the micro controller unit is performing an address operation cycle on the second address.

11. The flash memory embedded micro controller unit system of claim 10, wherein the flash control logic compares a third address with the next address stored in one of the registers, and when the third address is the same as the stored next address, the micro controller unit accesses the data of the next address stored in one of the registers.

12. The flash memory embedded micro controller unit system of claim 11, wherein the flash control logic compares the third address with the next address such that the micro controller unit accesses the third address to be accessed next to the second address after accessing the second address.

13. The flash memory embedded micro controller unit system of claim 10, wherein:
one of the registers is an instruction register; and
the flash control logic controls the flash memory block including the address next to the first address to store the next address of the first address and the data of the next address in the instruction register when the first address is an instruction address.

14. The flash memory embedded micro controller unit system of claim 10, wherein:
one of the registers is a data register; and
the flash control logic controls the flash memory block including the address next to the first address to store the next address of the first address and the data of the next address in the data register when the first address is a data address.

15. The flash memory embedded micro controller unit system of claim 11, wherein the flash control logic selects one of the registers on the basis of a code distinguishment signal output from the micro controller unit and compares the next address stored in the selected register with the third address output from the micro controller unit.

16. The flash memory embedded micro controller unit system of claim 15, wherein when the third address is different from the next address stored in the selected register, the micro controller unit accesses one of the flash memory blocks on the basis of the third address.

17. The flash memory embedded micro controller unit system of claim 10, further comprising a selector selecting either one of the registers or the data stored in one of the flash memory blocks under the control of the flash control logic,
wherein the micro controller unit accesses data selected by the selector.

18. A flash memory system, comprising:
a micro controller unit for determining whether a first address is consecutive to a second address; and performing an address operation cycle on the second address and a flash memory block that includes an address that is next to the first address when the first address is not consecutive to the second address storing a next address of the first address and data of the next address in one of a plurality of registers.

19. The system of claim 18, wherein the micro controller unit accesses a plurality of flash memory blocks using an interleaving technique.

20. The method of claim 1, wherein the micro controller unit per forms the address operation cycle.
